(19) United States
(12) Patent Application Publication
(10) Pub. No.: US 2013/0052989 A1
(43) Pub. Date: Feb. 28, 2013

(54) SYSTEM AND METHOD FOR LOAD BALANCING IN A COMMUNICATION NETWORK

(71) Applicant: Nagi Jayaraman Mahalingam, Nashua, NH (US)

(72) Inventor: Nagi Jayaraman Mahalingam, Nashua, NH (US)

(73) Assignee: RadiSys Corporation, Hillsboro, OR (US)

(21) Appl. No.: 13/216,774

(22) Filed: Aug. 24, 2011

(51) Int. Cl. H04W 12/06

(52) U.S. Cl. 455/411

(57) ABSTRACT

A system and method for achieving load balancing in a communication network. Each User Equipment (UE) configured to a Femto Access Point (FAP) is grouped under a particular access class based on the quality of service being subscribed to, by the UE. At the time of overloading, each access class is barred access for a particular percent of duty cycle. When an authorized UE requests connection to the FAP, the system checks for an overloading situation. If overloading is detected in the network, the system identifies the access class of that particular UE and checks if that particular access class is authorized to access the FAP at that particular instant of time. If the UE's access class is authorized to access the FAP at that instant of time, the system allow UE to establish connection.

### TECHNICAL FIELD

The embodiments herein relate to wireless communication networks and, more particularly, to load balancing in Femto cell based wireless communication networks.

### BACKGROUND

Load balancing is the process by virtue of which load in a network is divided among various network components performing same function. Load balancing helps to reduce overloading in a network. Major advantages of Load balancing comprise improved response time and redundancy. By means of load balancing, the load on each network components can be reduced which in turn help improve efficiency of the devices. Further, even if a network component fails to function, the other components take up the work of failed component and the system can be still kept functional.

Load balancing can be done using software or hardware or both. In an existing method for load balancing, a Femto Access Point (FAP) checks if overloading situation exists in the network. If overloading is detected in the network, the FAP rejects the connection request from the UE. Disadvantage of this method is that the UE will not be permitted to connect to the network till the overloading condition is eliminated.

In another existing method for load balancing, upon reception of connection request from a UE, the FAP checks if overloading situation exists in the network. If overloading is detected, the FAP redirects the request to a macro cell. A problem existing with this method is that a macro cell might not be able to provide as much signal strength as provided by a Femto cell.

### SUMMARY

In view of the foregoing, an embodiment herein provides a method for user equipment (UE) to connect to a Femto access point (FAP) in a Femto network. Upon reception of a connection request from the UE, the method checks if an overloading situation exists in the network. If an overloading situation is detected in the network, the method checks if the UE belongs to an authorized class. If the UE belongs to an authorized class, the method permits access for that particular UE. If the UE does not belong to an authorized class, the method denies connection for that particular UE.

Further, the Femto access network comprises a Femto access point (FAP). The FAP checks if an overloading situation exists in the network when the UE requests a connection. If an overloading situation is detected in the network, the FAP checks if the UE belongs to an authorized class. If the UE belongs to an authorized class, the FAP permits access for that particular UE. If the UE does not belong to an authorized class, the FAP denies connection for that particular UE.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a general block diagram of a Femto cell network as disclosed in the embodiments herein;

FIG. 2 is a block diagram which shows the components of a Femto Access Point (FAP) as disclosed in the embodiments herein;

FIG. 3 is a flow diagram which describes various steps involved in the process of allocation of access classes as disclosed in the embodiments herein; and

FIGS. 4A-4B are flow diagrams which describe various steps involved in the process of load balancing as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

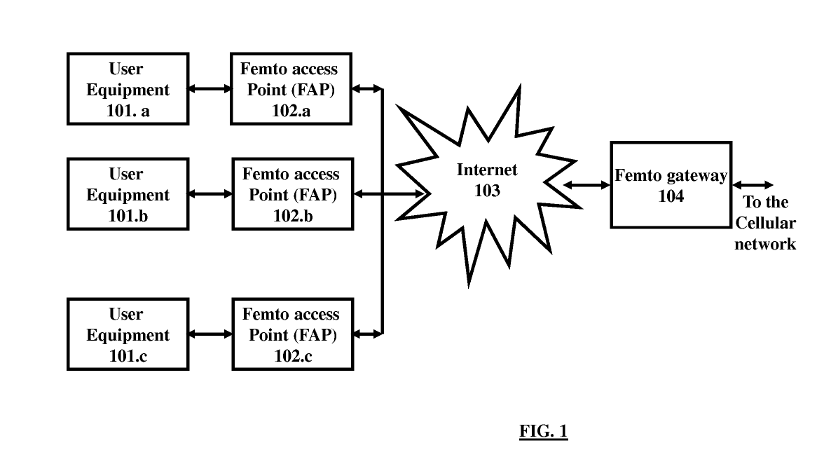

The embodiments herein disclose a method for load balancing in a Femto network by barring connection of each access class in corresponding periods of duty cycle. Referring now to the drawings, and more particularly to FIGS. 1 through 4B, where similar reference characters denote corresponding features consistently throughout the figures, there are shown embodiments.

FIG. 1 illustrates a general block diagram of a Femto cell network as disclosed in the embodiments herein. The system comprises User Equipments 101, Femto Access Point (FAP) 102, Internet 103 and Femto Gateway 104. The UEs 101 access the cellular network through FAP 102 and Femto gateway 104 over internet network 103. In an embodiment, UE 101 may be any mobile communication device such as mobile phone, laptops, PDAs and so on. Further, the FAP 102 accepts and processes connection requests from UE 101. In an embodiment, the FAP 102 checks if the UE 101 is permitted to access the FAP 102 upon reception of connection request from the UE 101. In another embodiment, the FAP 102 identifies a UE 101 using UE specific parameters. In another embodiment, the UE specific parameters may be any or all of International Mobile Subscriber Identity (IMSI)/Electronic Serial Number (ESN)/International Mobile Equipment Identity (IMEI) or any such user equipment specific parameter. In another embodiment, the FAP 102 categorizes UEs 101 into certain sets called access classes. In certain situations, the network may get overloaded, affecting the system performance adversely. In an embodiment, the network may get overloaded when multiple UEs 101 access the network and perform data transfer simultaneously. In another embodiment, the FAP 102 compensates for the overloading situation by selectively dropping services to UEs 101 in certain access classes. Further, FAP connects to the cellular network using an internet connection 103. The Femto gateway 104 manages traffic between FAPs 102 and the cellular network. In an embodiment, the Femto gateway 104 also perform authentication of each FAP and interfaces the FAP with mobile network core switches using standard protocols.

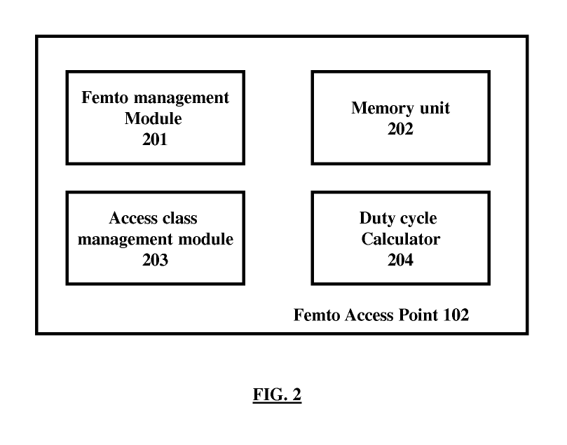

FIG. 2 is a block diagram which shows the components of a Femto Access Point (FAP) as disclosed in the embodiments herein. The FAP 102 comprises Femto Management Module (FMM) 201, memory unit 202, Access class Management Module (AMM) 203 and a Duty cycle Calculator (DC) 204. The Femto management module 201 is responsible for effective deployment of Femto cells in a communication network. Further, the Femto management module 201 processes the connection request from the UE 101. The memory unit 202 comprises a UE ID list which gives information about the UEs 101 which are permitted to access that particular FAP 102. The Access Class Management Module (AMM) 203 is responsible for allocation of access classes for UEs 101. In an embodiment, the AMM 203 allocates access classes for UE based on certain parameters. In another embodiment, the parameters considered while allocating access classes for UE may comprise Quality of Service (QOS) subscribed to by that UE 101, the nature of traffic (VoIP traffic may receive a higher priority than normal traffic and so on) and so on. The Duty cycle Calculator (DC) 204 present in the FAP 102 calculates duty cycle of that particular Femto network. In an embodiment, duty cycle implies the ratio of the time for which the network is active to the total time for which the machine is ON. In another embodiment, the calculation of duty cycle is needed for the purpose of load balancing.

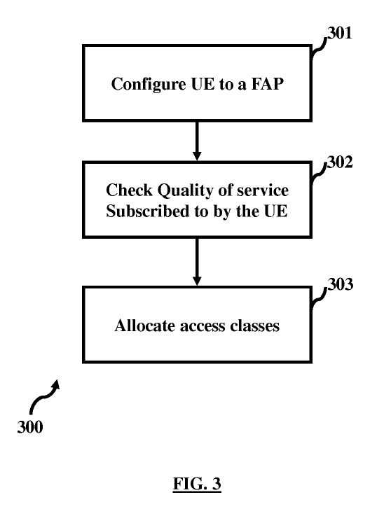

FIG. 3 is a flow diagram which describes various steps involved in the process of allocation of access classes as disclosed in the embodiments herein. A UE 101 can only access FAP/FAPs 102 which that particular UE is configured to. In an embodiment, the FAP 102 maintains a list of UEs which are permitted to access that particular FAP 102. In another embodiment, the list may comprise UE specific parameters for identification of UEs 101. In an embodiment, the UE specific parameters present in the list may be any or all of International Mobile Subscriber Identity (IMSI)/Electronic Serial Number (ESN)/International Mobile Equipment Identity (IMEI) or any such user equipment specific parameter. Once the UE 101 is configured to a FAP 102, the AMM 203 present in the FAP checks (302) Quality of Service subscribed by that UE. Based on the QOS, the AMM 203 assigns (303) access class for that particular UE. In an embodiment, UE 101 with high QOS is assigned to higher access classes. In another embodiment, UE 101 in higher access class has more chance of getting access to the access channels. The various actions in method 300 may be performed in the order presented, in a different order or simultaneously. Further, in some embodiments, some actions listed in FIG. 3 may be omitted.

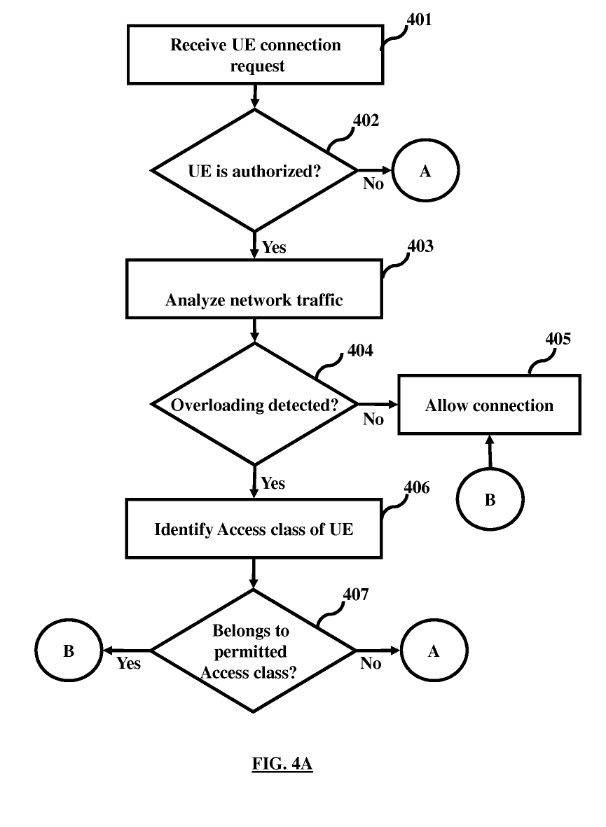

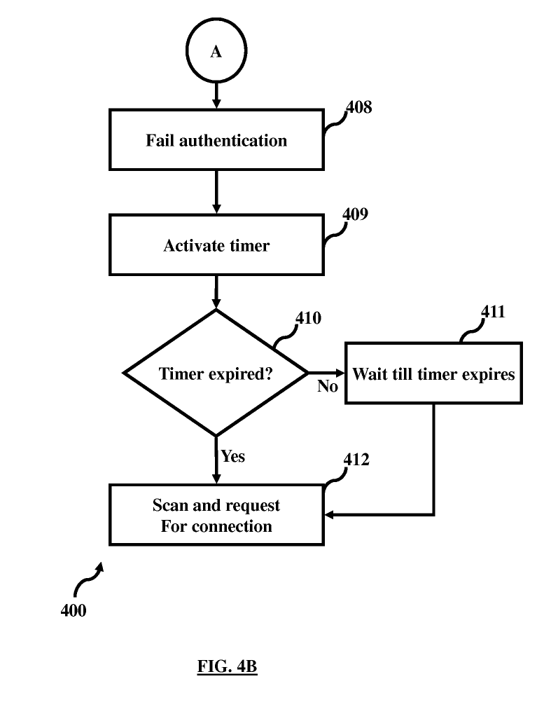

FIGS. 4A-4B are flow diagrams which describe various steps involved in the process of load balancing as disclosed in the embodiments herein. UE 101 initially makes a connection request to an FAP 102. The FAP receives (401) the connection request from UE 101 and checks (402) if the UE 101 is authorized to access the FAP 102. In an embodiment, the FAP 102 maintains a list of permitted users. In another embodiment, the FAP 102 verifies if the UE 101 is authorized or not by checking if that particular UE 101 is present list. If the UE 101 is authorized to access the FAP 102, the FAP analyzes (403) network traffic. In an embodiment, the FAP 102 analyzes network traffic so as to identify if an overloading condition exists in the network. The FAP then checks (404) if an overloading situation is detected in the network. If overloading is not detected, the UE 101 is allowed (405) to establish a connection to the FAP 102. If an overloading situation is detected, the Access class Management Module 203 identifies (406) the access class to which that particular UE 101 belongs to. Then the FAP checks (407) if the UE 101 belongs to a permitted access class or not. In an embodiment, at the time of overloading, the FAP 101 bars access for selected access classes. In another embodiment, the FAP 102 may use any one of a round robin method, fair queuing method, proportionally fair scheduling, maximum throughput algorithm to select the access class to be terminated at a particular period of duty cycle. The FAP 102 may also use any other suitable scheduling method to cycle through the classes. If the UE 101 is found to be a member of a permitted access class, that particular UE 101 is allowed to connect to the FAP 102. If the UE 101 is found to belong to an unauthorized service class, the FAP 102 fails (408) authentication of that particular UE 101. Upon authentication failure, the FAP 102 activates (409) a timer. In an embodiment, the timer may be a T3216 timer or any such suitable timer. In another embodiment, the timer value is preset by the system. The UE 101 waits till expiry of the timer. Once timer got expired, the UE 101 scans for a suitable FAP 102 and requests for connection. The various actions in method 400 may be performed in the order presented, in a different order or simultaneously. Further, in some embodiments, some actions listed in FIGS. 4A-4B may be omitted.

The embodiments disclosed herein can be implemented through at least one software program running on at least one hardware device and performing network management functions to control the network elements. The network elements shown in FIG. 2 include blocks which can be at least one of a hardware device, or a combination of hardware device and software module.

The embodiment disclosed herein specifies a system for load balancing in a communication network. The mechanism allows load balancing by selectively dropping a group of User Equipments (UE) providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for a User Equipment (UE) to connect to a Femto Access Point (FAP) in a Femto network, said method comprising:
checking if said UE belongs to an authorized class by said FAP, on said FAP receiving a request for a connection from said UE and said FAP detecting an overload in said Femto network;
permitting said UE to connect to said FAP, if said UE belongs to said authorized class; and
denying connection to said UE by said FAP, is said UE does not belong to said authorized class.

2. The method, as claimed in claim 1, wherein said method further comprises assigning a class to said UE by said FAP, on said UE attempting to connect to said FAP for first time.

3. The method, as claimed in claim 2, wherein said method further comprises checking if said UE is authorized to connect to said FAP, before assigning said class to said UE.

4. The method, as claimed in claim 2, wherein said FAP assigns said class to said UE based on a plurality of factors comprising:
quality of service expected by said UE; and
type of traffic from said UE.

5. The method, as claimed in claim 1, wherein said FAP cycles through classes assigned to a plurality of UEs.

6. The method, as claimed in claim 5, wherein said FAP cycles through classes assigned to a plurality of UEs using at least one of:
a round robin method;
a fair queuing method;
proportionally fair scheduling; and
a maximum throughput algorithm.

7. The method, as claimed in claim 1, wherein said method further comprises:
starting a timer by said UE, on said UE being denied connection to said FAP; and
re-attempting to connect to said FAP by said UE, on expiry of said timer.

8. A Femto Access Point (FAP) in a Femto network, said FAP comprising at least one means adapted for:
checking if a UE belongs to an authorized class by said FAP, on said FAP receiving a request for a connection from said UE and said FAP detecting an overload in said Femto network;
permitting said UE to connect to said FAP, if said UE belongs to said authorized class; and
denying connection to said UE by said FAP, is said UE does not belong to said authorized class.

9. The FAP, as claimed in claim 8, wherein said FAP is configured for assigning a class to said UE by said FAP, on said UE attempting to connect to said FAP for first time.

10. The FAP, as claimed in claim 9, wherein said FAP is configured for checking if said UE is authorized to connect to said FAP, before assigning said class to said UE.

11. The FAP, as claimed in claim 9, wherein said FAP is configured to assign said class to said UE based on a plurality of factors comprising:
quality of service expected by said UE; and
type of traffic from said UE.

12. The FAP, as claimed in claim 8, wherein said FAP is configured to cycle through classes assigned to a plurality of UEs.

13. The FAP, as claimed in claim 12, wherein said FAP is configured to cycle through classes assigned to a plurality of UEs using at least one of:
a round robin method;
a fair queuing method;
proportionally fair scheduling; and
a maximum throughput algorithm.
